(19) United States
(12) Patent Application Publication
(10) Pub. No.: US 2025/0261181 A1
(43) Pub. Date: Aug. 14, 2025

(54) POSITIONING ASSISTED BEAM MANAGEMENT

(71) Applicant: Samsung Electronics Co., Ltd., Suwon-si (KR)

(72) Inventors: Emad Nader Farag, Flanders, NJ (US); Aristides Papasakellariou, Houston, TX (US); Eko Onggosanusi, Coppell, TX (US)

(21) Appl. No.: 19/036,855

(22) Filed: Jan. 24, 2025

Related U.S. Application Data
(60) Provisional application No. 63/551,366, filed on Feb. 8, 2024.

(51) Int. Cl. H04W 72/044; H04W 64/00

(52) U.S. Cl. CPC H04W 72/046; H04W 64/00

(57) ABSTRACT

Methods and apparatuses for positioning assisted beam management. A method of operating a user equipment (UE) includes receiving first configuration information for one or more transmission occasions for one or more first signals, respectively, that indicates periodicity of the one or more transmission occasions and an offset relative to a reference source and synchronizing to the reference source for timing information. The method further includes evaluating a condition to transmit a first signal from the one or more first signals, determining the first signal, and when the condition is satisfied, transmitting the first signal in a corresponding transmission occasion and receiving, in response to the first signal, a second signal for beam management.

### CROSS-REFERENCE TO RELATED AND CLAIM OF PRIORITY

The present application claims priority under 35 U.S.C. § 119 (e) to U.S. Provisional Patent Application No. 63/551,366 filed on Feb. 8, 2024, which is hereby incorporated by reference in its entirety.

### TECHNICAL FIELD

The present disclosure relates generally to wireless communication systems and, more specifically, the present disclosure relates to methods and apparatuses for positioning assisted beam management.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to positioning assisted beam management.

In one embodiment, a user equipment (UE) is provided. The UE includes a transceiver configured to receive first configuration information for one or more transmission occasions for one or more first signals, respectively, that indicates periodicity of the one or more transmission occasions and an offset relative to a reference source, and synchronize to the reference source for timing information. The UE further includes a processor operably coupled to the transceiver. The processor is configured to evaluate a condition to transmit a first signal from the one or more first signals and determine the first signal. The transceiver is further configured to, when the condition is satisfied, transmit the first signal in a corresponding transmission occasion, and receive, in response to the first signal, a second signal for beam management.

In another embodiment, a base station (BS) system is provided. The BS system includes a first BS comprising a transceiver and a processor operably coupled with the transceiver and one or more second BSs. A second BS of the one or more second BSs comprises a transceiver and a processor operably coupled with the transceiver. The transceiver of the first BS is configured to transmit first configuration information for one or more transmission occasions for one or more first signals, respectively. The first configuration information indicates periodicity of the one or more transmission occasions and an offset relative to a reference source. The transceiver of the second BS is configured to receive the first signal. The processor of the second BS configured to detect a presence of the first signal. The transceiver of the second BS further configured to transmit, in response to the first signal, a second signal for beam management.

In yet another embodiment, a method of operating a UE is provided. The method includes receiving first configuration information for one or more transmission occasions for one or more first signals, respectively, that indicates periodicity of the one or more transmission occasions and an offset relative to a reference source and synchronizing to the reference source for timing information. The method further includes evaluating a condition to transmit a first signal from the one or more first signals, determining the first signal, and when the condition is satisfied, transmitting the first signal in a corresponding transmission occasion and receiving, in response to the first signal, a second signal for beam management.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates a timeline for beam measurement according to embodiments of the present disclosure;

FIG. 11 illustrates an example system for beam measurement according to embodiments of the present disclosure;

FIG. 12 illustrates a timeline for transmission/reception of a beam management reference signal according to embodiments of the present disclosure;

FIG. 13 illustrates a timeline for transmission/reception of a beam management reference signal according to embodiments of the present disclosure;

FIG. 14 illustrates an example system for trigger signal transmission/reception according to embodiments of the present disclosure;

FIG. 15 illustrates an example system for trigger signal transmission/reception according to embodiments of the present disclosure;

FIGS. 16A, 16B and 16C illustrate example diagrams for signal transmission according to embodiments of the present disclosure;

FIG. 17 illustrates a flowchart of an example procedure for beam management according to embodiments of the present disclosure;

FIG. 18 illustrates a flowchart of an example procedure for beam management according to embodiments of the present disclosure; and

FIG. 19 illustrates a flowchart of an example procedure for beam management according to embodiments of the present disclosure.

### DETAILED DESCRIPTION

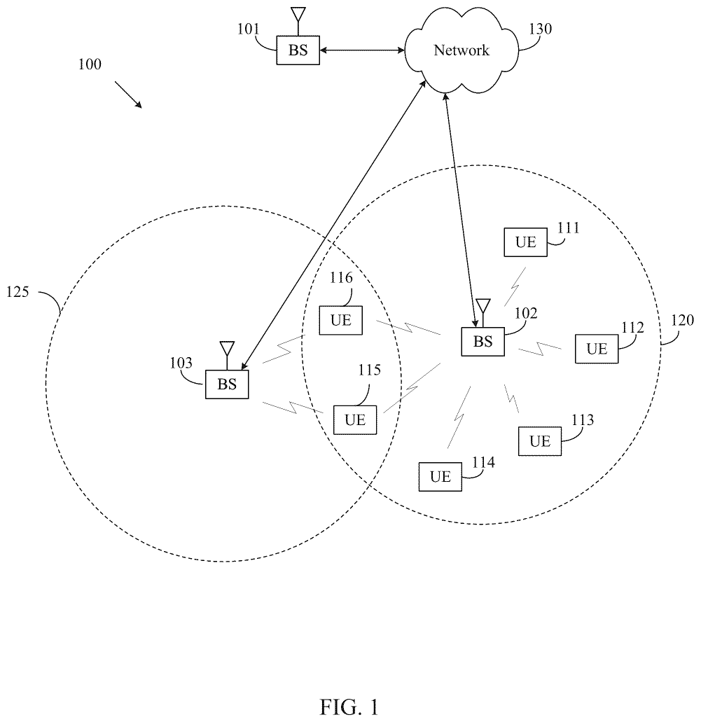

FIGS. 1-19, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.1.0, “NR; Physical channels and modulation;” [REF 2] 3GPP TS 38.212 v18.1.0, “NR; Multiplexing and channel coding;” [REF 3] 3GPP TS 38.213 v18.1.0, “NR; Physical layer procedures for control;” [REF 4] 3GPP TS 38.214 v18.1.0, “NR; Physical layer procedures for data;” [REF 5] 3GPP TS 38.321 v18.0.0, “NR; Medium Access Control (MAC) protocol specification;” and [REF 6] 3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for positioning assisted beam management. In certain embodiments, one or more of the gNBs 101-103 include circuitry, programing, or a combination thereof to support positioning assisted beam management.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

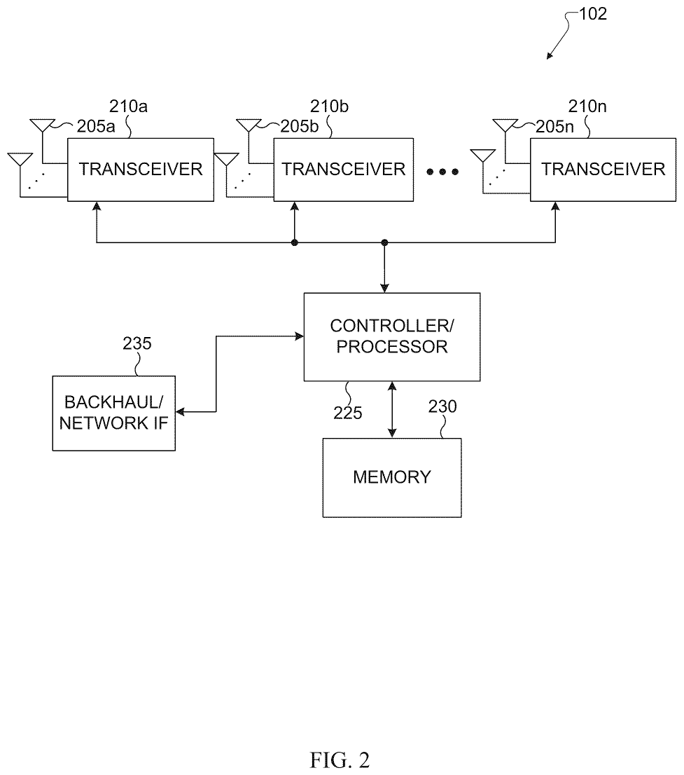

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting positioning assisted beam management. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

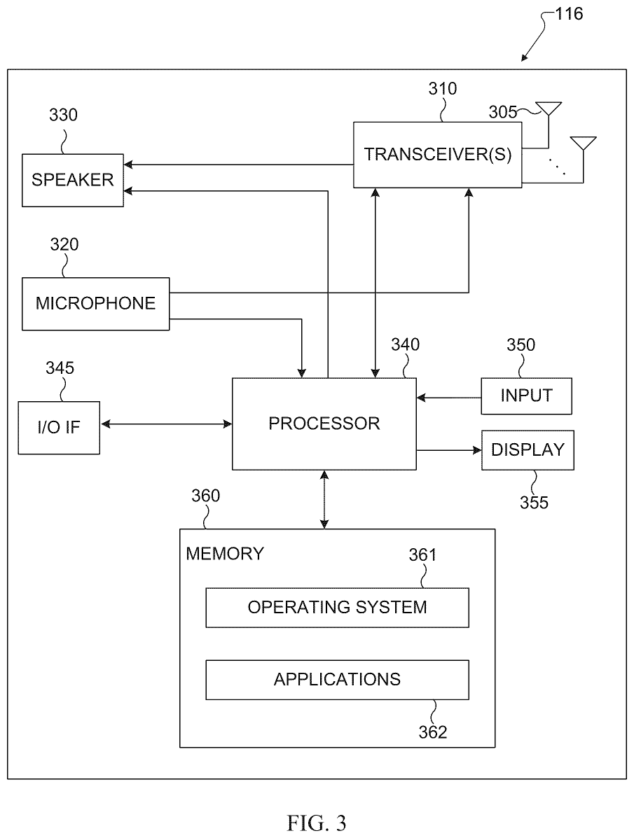

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform positioning assisted beam management. as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

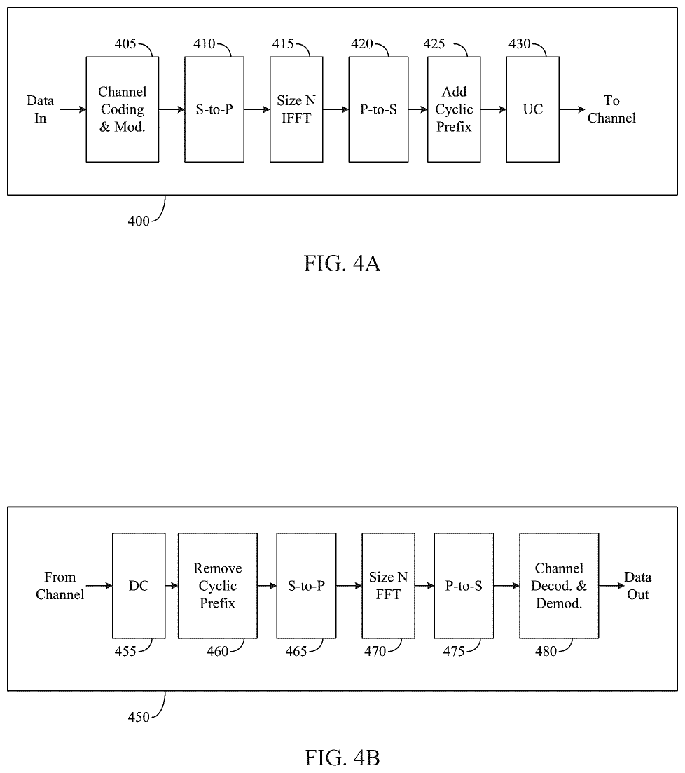

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 supports positioning assisted beam management. as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

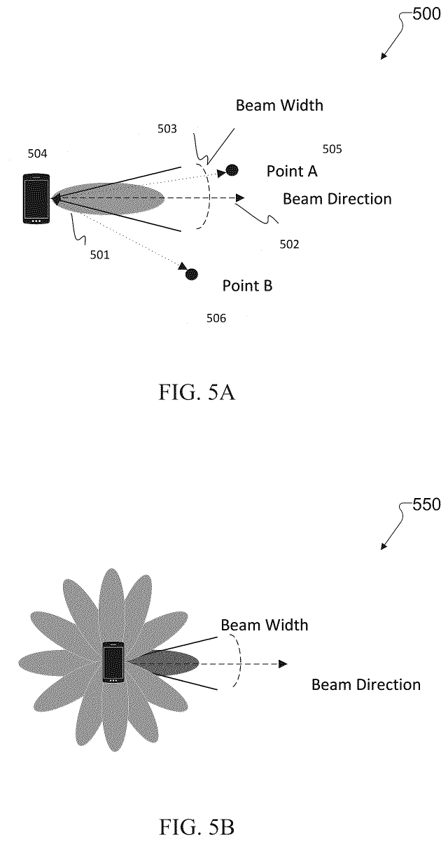

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

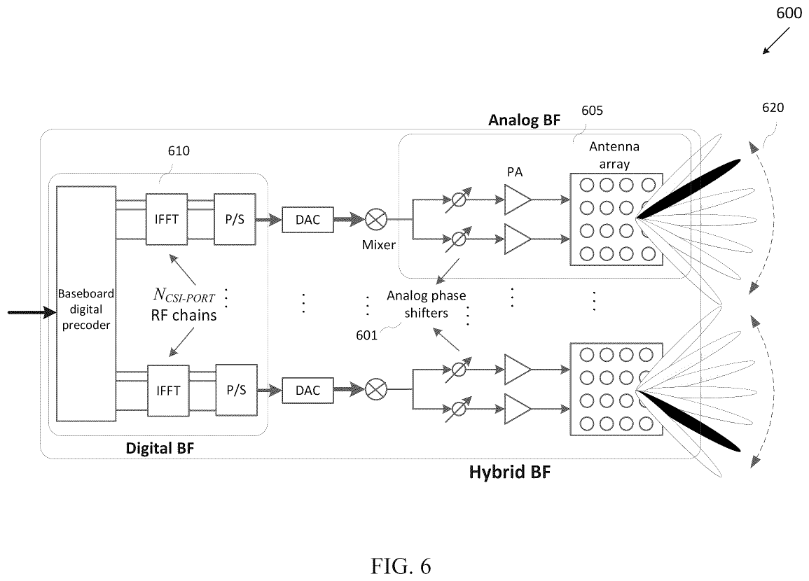

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam can be determined by any of;
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB (e.g., the BS 102), or a spatial Rx filter for reception of uplink channels at the gNB.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214-section 5.1.5] [REF 4]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

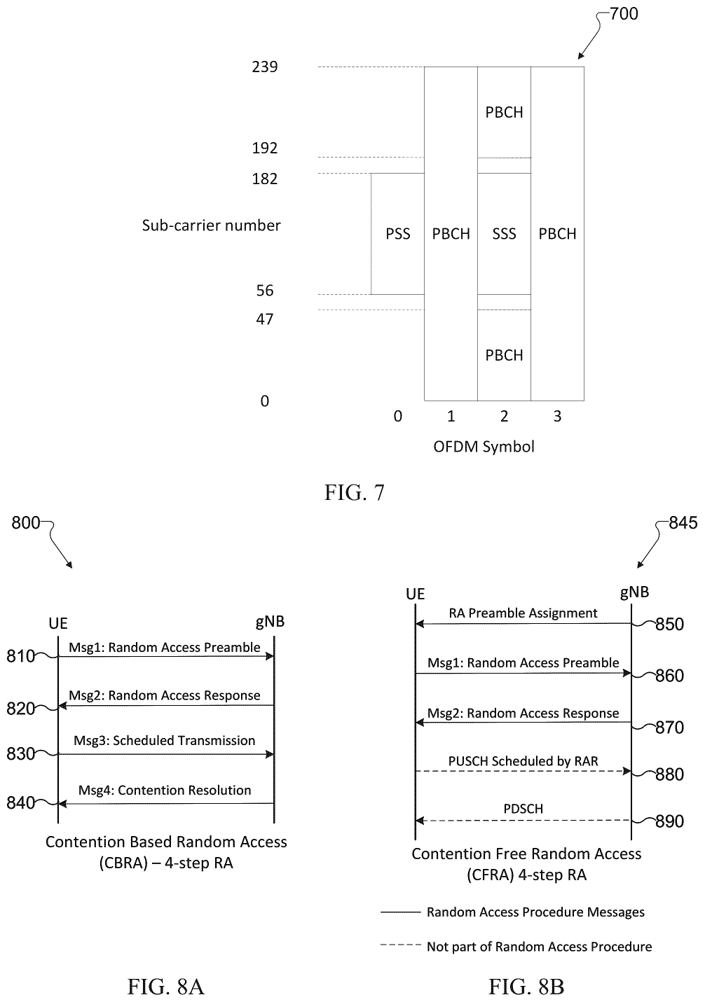

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE (e.g., the UE 116) performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A primary synchronization signal (PSS)/secondary synchronization signal (SSS)/PBCH block (SS/PBCH block) is referred to as SSB and includes 4 consecutive symbols, and 20 physical resource blocks (240 subcarriers), as illustrated in FIG. 7.

SSBs are organized in groups (bursts) of up to N SSBs, transmitted within half a frame, each SSB within the group (burst) has an index i, where i=0, 1, . . . , N−1, within each group (burst) of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of physical resource blocks (PRBs)) and the resource allocated to an RO in the time domain (e.g., number of OFDMA symbols or number of slots), depend or the preamble sequence length, sub-carrier spacing of the preamble, sub-carrier spacing of the PUSCH in the UL bandwidth part (BWP), and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 [REF 1] v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0] [REF 3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

There are two types of random access procedures, type-1 random access procedure and type-2 random access procedure.

Type-1 random access procedure also known as four-step random access procedure (4-step RACH), is as illustrated in FIG. 8A;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC request setup message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

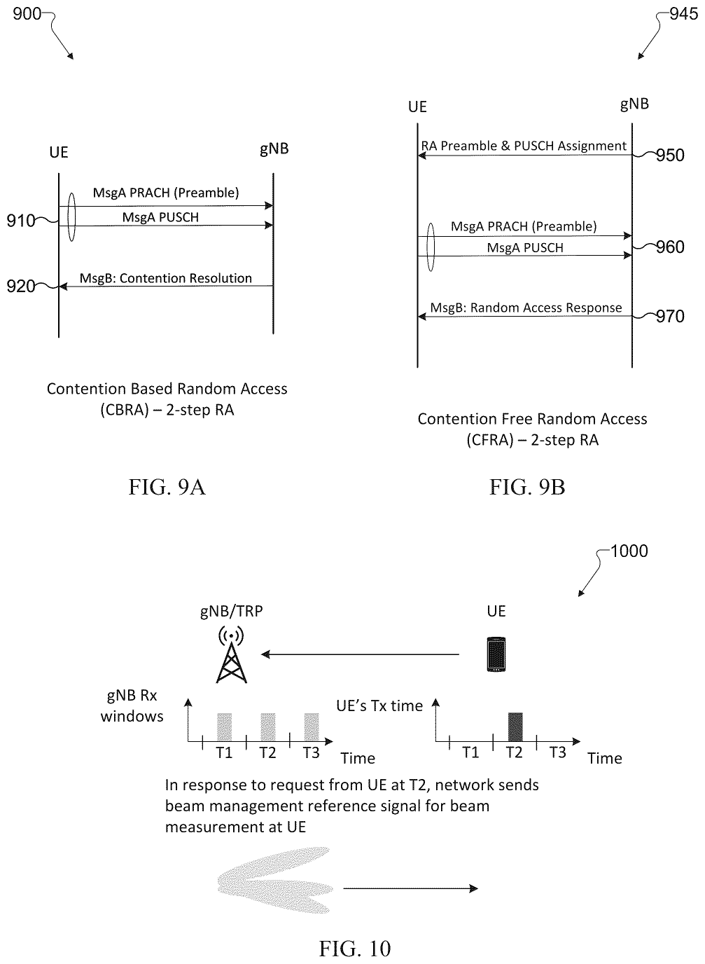

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16, introduced a new random access procedure; Type-2 random access procedure, also known as 2-step random access procedure (2-step RACH), is as illustrated in FIG. 9A, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with a reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding random access radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a cell-RNTI (C-RNTI), the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

In NR/5G, as a UE in RRC_CONNECTED mode moves around, the UE can connect to the network through different cells or different beams. There are two types of network controlled mobility procedures for UEs in RRC_CONNECTED mode: (1) Cell Level Mobility, also referred to as handover, that requires RRC signaling to be triggered and the UE changes its serving cell from a source serving cell to a target serving cell, and (2) Beam Level Mobility, that includes intra-cell beam level mobility and inter-cell beam level mobility and doesn't require explicit RRC signaling to be triggered. To improve handover procedures, 3GPP introduced several handover enhancements which include:
Dual Active Protocol Stack (DAPS): The source gNB connection is maintained, i.e., a UE continues DL data reception from the source gNB and UL data transmission to the source gNB, after reception of the RRC message for handover, and until the source gNB is released after successful random access to the target gNB.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed.
L1/L2 Triggered Mobility (LTM). The gNB prepares and provides candidate cell(s) configuration(s) to the UE. The physical layer provides measurement reports that include reference signal received power (RSRP) of SS/PBCH blocks of candidate cell(s). Based on the measurement reports, the gNB can change the serving cell to a target cell through a cell switch command signaled via MAC CE. The UE switches to the target cell following the cell switch command. The benefit of cell switch command is to reduce handover latency.

NR devices (e.g., UE or gNB) can support radio access technology (RAT) independent positioning schemes and RAT dependent positioning schemes. RAT independent positioning schemes include global navigation satellite systems (GNSS), WLAN (e.g. WiFi), Bluetooth, Terrestrial Beacon System (TBS), as well as sensors within the UE such as accelerometers, gyroscopes, magnetometers, etc. Some of the UE sensors are also known as Inertial Measurement Unit (IMU). NR/5G RAT dependent positioning schemes can use the Uu interface (UL/DL interface) and/or the PC5 interface ((sidelink SL) interface). An NR device (e.g., UE or gNB), can obtain timing information from the received signal, for example using GNSS an NR device can obtain global timing information.

In the DL, positioning reference signal (PRS) can be transmitted by a gNB to a UE to enable the UE to perform positioning measurements. In the UL, a UE can transmit positioning sounding reference signal (SRS) to enable a gNB to perform positioning measurements. UE measurements for positioning include; DL PRS reference signal receive power (DL PRS RSRP), DL PRS reference signal received path power (DL PRS-RSRPP), DL reference signal time difference (DL RSTD), UE Rx-Tx time difference, DL reference signal carrier phase (DL RSCP), DL reference signal carrier phase difference (DL RSCPD), NR enhanced cell ID (E-CID) DL SSB radio resource management (RRM) measurement, and NR E-CID DL CSI-RS RRM measurement. NG-RAN measurements for positioning include; UL SRS reference signal received power (UL SRS-RSRP), UL SRS reference signal received path power (UL SRS-RSRPP), UL relative time of arrival (UL-RTOA), UL angle of arrival (UL AoA), gNB Rx-Tx time difference, and UL reference signal carrier phase (UL RSCP). NR introduced several radio access technology (RAT) dependent positioning methods; time difference of arrival based methods such DL time difference of arrival (DL-TDOA) and UL time difference of arrival (UL TDOA), angle based methods such as UL angle of arrival (UL AoA) and DL angle of departure (DL AoD), multi-round trip time (RTT) based methods, carrier phase based methods and E-CID based methods.

In the SL, SL positioning reference signal (SL PRS) can be transmitted by a first UE to enable a second UE to perform SL positioning measurements. SL positioning measurement include: SL PRS reference signal received power (SL PRS-RSRP), SL PRS reference signal received path power (SL PRS-RSRPP), SL relative time of arrival (SL-RTOA), SL reference signal time difference (SL RSTD), SL angle of arrival (SL AoA) and SL Rx-Tx time difference.

This disclosure provides using a global time and positioning information to assist with beam management functionality. For example, using a global time, a UE can determine when to transmit a signal to initiate communication (e.g., initiate beam acquisition) with a gNB/TRP. Furthermore, using positioning information of the UE and gNB/TRP can help limit a subset of beams used for beam sweeping for example, during initial access or during mobility.

FIG. 10 illustrates a timeline 1000 for beam measurement according to embodiments of the present disclosure. For example, timeline 1000 can be followed by the UE 116 of FIG. 3 and gNB 102 of FIG. 1. This example is for illustration only and other embodiments can be used without departing from the scope of the present disclosure.

In FR2, a beam-based air interface is used to mitigate the additional pathloss due to the higher carrier frequency compared to FR1. To enhance the overall system performance, beams with high gain (i.e., narrow beams) are used, hence a large number of beams can be transmitted by a gNB on a cell. With a large number of beams, beam pairing time is increased, especially when reference signals used for beam management such as SS/PBCH blocks are time-division multiplexed as in NR. Furthermore, a large number of beams having “always on” beam management reference signals increase the network's energy consumption. To mitigate both of these issues, use of a global time and the positioning of the UE are provided to transmit a subset of beam management reference signals when needed by the UE.

To minimize “always on” reference signals for beam management, a UE can send a request to network when the UE wants to do beam measurements. For example, this can be for initial access (e.g., initial beam pairing between the UE and gNB/TRP of the network), for mobility (e.g., for handover, where the UE identifies a beam pair for a new gNB/TRP), or for beam tracking and refinement or beam failure recovery. To minimize the network's energy consumption, the gNB/TRP receiver wakes up for a short time period periodically (or at certain time intervals), referred to as the gNB Rx window, or as timing window, to listen to any UE request for beam management reference signal. If the gNB/TRP detects a request, it transmits the beam management reference signal; otherwise, there is no transmission from the gNB/TRP as illustrated in FIG. 10. For the gNB/TRP to detect a trigger signal from the UE, the UE needs to transmit the trigger signal during the timing window. Therefore, embodiments of the present disclosure recognize that both the gNB and the UE need to be synchronized to the same time source. If the UE has accessed the network, the UE can synchronize its timing to that of the network. If the UE has accessed an NTN network, the UE can synchronize its timing to that of NTN network. If the UE has not accessed the network, e.g., before initial access, the time source can be an external source, for example using GNSS where the gNB and the UE can both acquire a same time reference (e.g., a global time reference) and use that to determine the timing window and the UE's transmission time of the trigger signal.

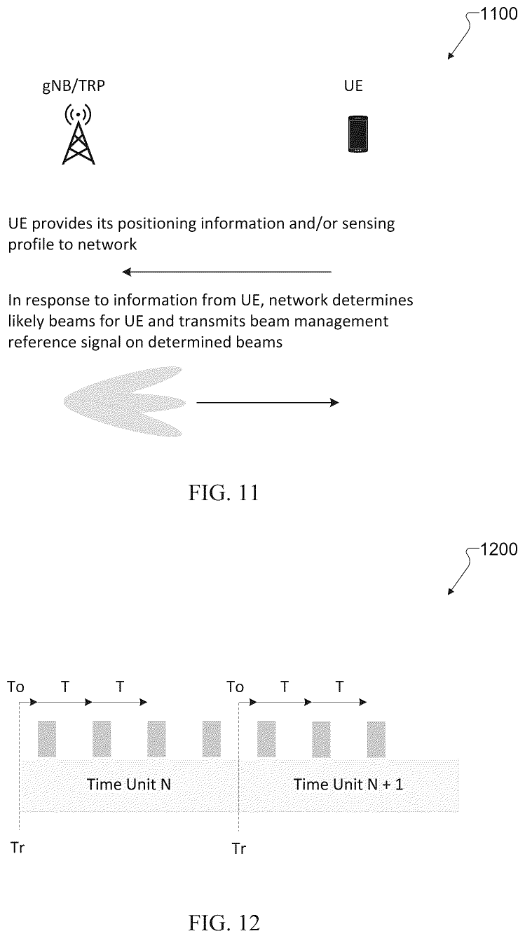

FIG. 11 illustrates an example system 1100 for beam measurement according to embodiments of the present disclosure. For example, system 1100 can be implemented in the wireless network 100 of FIG. 1. This example is for illustration only and other embodiments can be used without departing from the scope of the present disclosure.

To minimize a number of transmitted beam management reference signals, a UE can provide to the network/gNB information related to its positioning or location. The UE may additionally provide a sensing profile. That information can help the gNB determine the multi-path characteristics of the channel. This can then help determine a subset of beams that are likely to be used for communication between the gNB and UE. For example, in a line-of-sight channel as illustrated in FIG. 11, a UE provides to the network its location information and, based on that information, the network determines the beams that the UE is likely to use and transmits these beams for the UE to perform beam sweeping and identify a best beam.

This disclosure provides design aspects related to the trigger signal from the UE, to trigger transmission of beam management reference signals. This disclosure also provide design aspects related to positioning and/or sensing profile information the UE can provide to the network (gNB/TRP) to assist the network in determining a subset of beams and associated reference signals for beam management that can be used for communication between the gNB/TRP and the UE.

The present disclosure relates to a 5G/NR and/or 6G communication system.

This disclosure provides aspects related to design of beam management reference signal that provides a mechanism to trigger beam management reference signals on demand, and provide relevant assistance information based on positioning and/or sensing to tailor the transmission of beam management reference signal to what is needed and when it is needed, hence making the beam management procedure more efficient and with reduced latency. This disclosure includes including:
Triggering transmission of beam management reference signals.
Using positioning information and/or sensing information to determine the beams on which beam management reference signals are transmitted.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) (e.g., the BS 102) and, based on the first information, the UE determines a starting point a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as nonzero power (NZP) CSI-RS and/or SSB) with the result of the measurement used for calculating a beam report (e.g., including at least one L1-RSRP/L1-signal-to-interference-plus-noise ratio (SINR) accompanied by at least one channel quality indicator report interval (CRI) or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, a beam management reference signal reference refers to a reference signal, a UE can use for beam management procedure. A beam management procedure can include:
Initial beam acquisition for identifying a beam or a beam pair between two devices (e.g., UE and gNB/TRP or between two UEs) during channel setup or link establishment. This includes initial beam sweeping to identify a beam pair between two UEs. This can also include identifying a beam or a beam pair between a UE and new gNB/TRP in case of handover.
Beam maintenance for refining and tracking the beam as the UE moves around or the channel conditions change. This includes beam measurement and reporting, and beam indication signaling.
Beam failure detection and recovery, an emergency-only procedure for determining when a beam has failed, and identifying a new beam to use instead. Beam failure events are typically rare and, in the unlikely event that a beam fails, beam recovery should be fast and before the link fails.

A beam management reference signal can include:
A SS/PBCH block, which includes one or more synchronization signals carrying a cell ID (or a gNB/TRP ID or a radio unit identifier (RU ID)), and a channel carrying minimum system information or part of the minimum system information, wherein the minimum system information is the information required by the UE (e.g., the UE 116) to access the network (e.g., the network 130).
low power synchronization signal (LP-SS). In one example, LP-SS includes one or more synchronization signals carrying a cell ID (or a gNB/TRP ID or a RU ID). In one example, LP-SS is based on on-off keying modulation. In one example, LP-SS is received or transmitted on a low power radio separate from the main radio. In one example, the LP-SS is not associated with PCI. In one example, the LP-SS is associated with PCI.
Channel state information reference signal (CSI-RS). In one example, the CSI-RS is not associated with a PCI. In one example, the CSI-RS is associated with PCI. In one example, the CSI-RS is QCLed with another CSI-RS. In one example, the CSI-RS is associated with PCI. In one example, the CSI-RS is QCLed with SS/PBCH block. In one example, the CSI-RS is QCLed with LP-SS. In one example, the CSI-RS has no source RS, e.g., the CSI-RS is the root of the QCL relation. In one example, the CSI-RS has one antenna port. In one example, the CSI-RS has more than one antenna port.
Sounding reference signal (SRS)
One of the reference signals mentioned herein transmitted on the SL interface.

In one example of this disclosure, the reference signal for beam management can include more than one reference signal.
A first reference signal for beam management e.g., for initial beam acquisition for initial access.
A second reference signal for beam management e.g., for initial beam acquisition for mobility (e.g., handover).
A third reference signal for beam management e.g., for beam maintenance (e.g., beam tracking and/or beam refinement)
A fourth reference signal for beam management e.g., for beam failure detection.
A fifth reference signal for beam management e.g., for beam failure recovery.

In one example, more than one of the reference signals mentioned herein can be same. For example, the first and the second reference signals can be same. For another example, the first and the second the fourth reference signals can be same.

In one example, there is one reference signal for beam management. In one example, a reference signal can be used for beam management and for other purposes such as tracking or channel state information (CSI) acquisition.

In one example, the configuration of the reference signal for beam management can be adapted or updated, by RRC signaling and/or MAC CE signaling and/or L1 control signaling.

In one example, the configuration of the beam management reference signal can include at least:
Type of reference signal, e.g., SS/PBCH block, or LP-SS or CSI-RS or SRS.
Time and frequency resources.
Sequence for reference signal.
Power for reference signal.

FIG. 12 illustrates a timeline 1200 for transmission/reception of a beam management reference signal according to embodiments of the present disclosure. For example, timeline 1200 can be followed by any of the UEs 111-116 of FIG. 1 and/or the gNB 102 of FIG. 1. This example is for illustration only and other embodiments can be used without departing from the scope of the present disclosure.

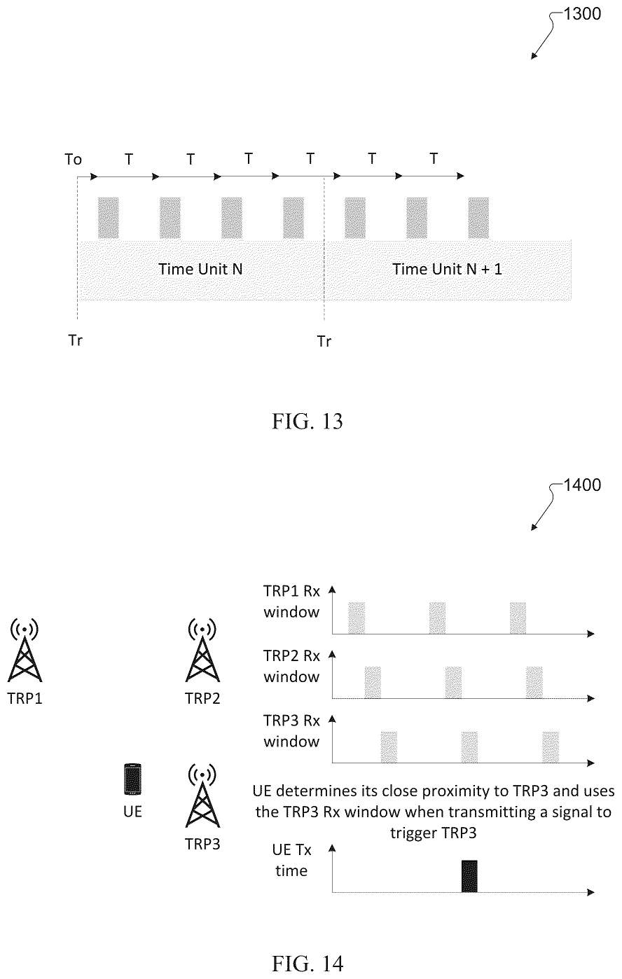

FIG. 13 illustrates a timeline 1300 for transmission/reception of a beam management reference signal according to embodiments of the present disclosure. For example, timeline 1300 can be followed by the UE 111 of FIG. 1 and/or the gNB 102 of FIG. 1. This example is for illustration only and other embodiments can be used without departing from the scope of the present disclosure.

In one example, a first device (e.g., UE) can trigger a second device (e.g., gNB/TRP) to transmit a beam management reference signal. In one example, the second device has a timing window for receptions, wherein the second device attempts to receive a trigger signal from the first device within the timing window (timing window for transmissions from the first device). In one example, the timing window has a periodicity of T and an offset of To, wherein the offset is relative to a reference time Tr. The offset may also have a zero value (no To). In one example, an instance of the timing window starts at time Tr+To+n*T, wherein n is an integer. In one example, the timing window has a duration D. In one example, the times mentioned herein can be in units of symbols and/or slots and/or subframes and/or frames and/or unit of time (e.g., ms or second, etc.). In one example, the time between a timing window and next occurrence of the timing window is T.

In one example, the first and second devices are synchronized to an external time source, e.g., external to the network, e.g., a global time source, e.g., based on GNSS or TBS. In one example, the reference time Tr is based on a global time, e.g., based on GNSS. In one example, Tr is time zero of global time. In one example, Tr is the start of a unit time of the global time. In one example, Tr can be the start of the time unit before the timing window as illustrated in FIG. 12. In one example, Tr can be time unit N as illustrated in FIG. 13. In one example, the time unit is milli-seconds. In one example, the time unit is 10 milli-seconds. In one example, the time unit is 100 milli-seconds. In one example, the time unit is seconds. In one example, the time unit is 10 seconds. In one example, the time unit is minutes. In one example, the time unit is hours. In one example, the time unit is days.

In one example, the first and second devices are synchronized to the network (e.g., network time source). In one example, the network can be a terrestrial network (TN). In one example, the network can be a non-terrestrial network NTN. In one example, the reference time Tr is based on a network time. In one example, Tris time zero of the network, e.g., time of system frame number (SFN) zero (e.g., at the start of SFN 0).

In the examples mentioned herein:
In one example, a first device is a UE, and a second device is a gNB/TRP.
In one example, a first device is a first UE, and a second device is a second UE.
In one example, a first device is a gNB/TRP, and a second device is a UE.
In one example, a first device is a first network device (e.g., first gNB/TRP) and a second device is a second network device (e.g., second gNB/TRP).

In one example, the first device and/or the second device are (pre-)configured with T.

In one example, the first device and/or the second device are (pre-)configured with To.

In one example, the first device and/or the second device are (pre-)configured with Tr.

In one example, the first device and/or the second device are (pre-)configured with D.

In one example, D is the duration of the trigger signal sent by the UE. In one example, D is the duration of N instances of the trigger signal as described later in this disclosure.

In one example, T and/or To and/or Tr and/or D can be updated by system information. In one example, T and/or To and/or Tr and/or D can be updated by system information in FR1. In one example, T and/or To and/or Tr and/or D can be updated by system information in FR2 for example, after the UE has connected to the network.

FIG. 14 illustrates an example system 1400 for trigger signal transmission/reception according to embodiments of the present disclosure. For example, system 1400 can be implemented in the wireless network 100 of FIG. 1. This example is for illustration only and other embodiments can be used without departing from the scope of the present disclosure.

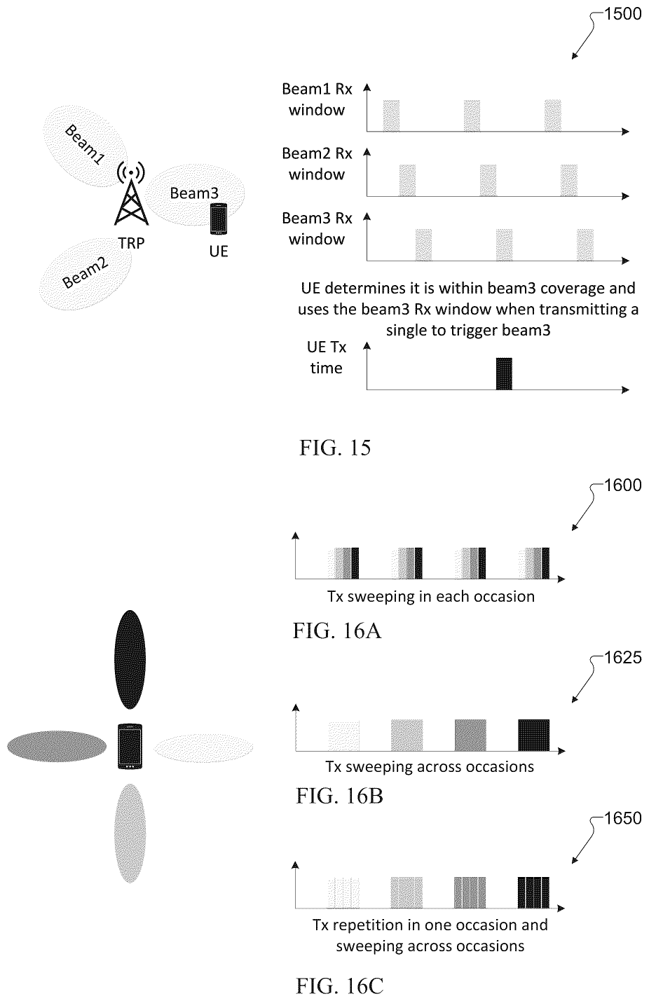

FIG. 15 illustrates an example system 1500 for trigger signal transmission/reception according to embodiments of the present disclosure. For example, system 1500 can be implemented in the wireless network 100 of FIG. 1. This example is for illustration only and other embodiments can be used without departing from the scope of the present disclosure.

In one example, T and/or To and/or Tr and/or D can depend on the second device and/or the beam of the second device receiving the trigger signal. In one example, the configuration of the timing window of the trigger signal, e.g., time and/or frequency resources can depend on the second device and/or the beam of the second device receiving the trigger signal. In one example, the configuration of the trigger signal, e.g., sequence used for trigger signal can depend on the second device and/or the beam of the second device receiving the trigger signal. In one example, the first device (e.g., UE) is informed or configured the resources of the timing window of the trigger signal or the configuration of the trigger signal of the second device(s) and/or the beams of the second device(s). The first device determines, as described later in this disclosure, a second device and/or a beam of a second device to send the trigger signal and selects the corresponding resources and/or configuration to transmit the trigger signal. The resources may be valid only within the timing window and may not be valid outside the timing window. The signal can serve additional purposes such as to initiate transmissions by the second device in addition to the reference signal for beam management.

FIG. 14 illustrates one such example. In FIG. 14, there are three TRPs (second devices receiving the trigger signal), TRP1, TRP2 and TRP3, each TRP has a different timing window (e.g., time/frequency occasion) for the trigger signal. In one such example, the offset of the trigger signal from a reference time can be different for each TRP as illustrated in FIG. 14. The configuration of the timing window can be per TRP or can be common for TRPs. In another example, the resources used for the timing window of the trigger signal (e.g., frequency resources such as PRBs or sub-carriers and/or time resources such as symbols) can be configured per TRP or can be common for TRPs. In another example, the configuration of the trigger signal (e.g., sequence used for trigger signal) can be per TRP or can be common for TRPs. The UE (first device transmitting the trigger signal) is informed or configured the resources of the timing window and/or the configuration of the trigger signal of each TRP. The UE determines which TRP or TRPs to send the trigger signal to, and hence determine the corresponding time/frequency occasion and trigger signal. In one example, this can be based on positioning information, the UE is configured or informed the position or location of each TRP, the UE determines its position (e.g., using non-RAT-based methods and/or using RAT-based methods), the UE determines the most suitable (e.g., closest) TRP or TRPs to transmit the trigger signal to. In one example, this can be based on sensing information, the UE determines the most suitable (e.g., closest) TRP or TRPs to transmit the trigger signal to. Based on the determined TRP or TRPs and on the corresponding timing window and/or configuration of the trigger signal, the UE transmits the determined trigger signal to the determined TRP or TRPs.

FIG. 15 illustrates one such example. In FIG. 15, there is a TRP (second device receiving the trigger signal) with three beams (spatial domain filters), beam1, beam2 and beam3, wherein each beam has a different timing window (e.g., time/frequency occasion) for the trigger signal. In one such example, the offset of the trigger signal from a reference time can be different for each beam as illustrated in FIG. 15. The configuration of the timing window can be per beam or can be common for beams. In another example, the resources used for the timing window of the trigger signal (e.g., frequency resources such as PRBs or sub-carriers and/or time resources such as symbols) can be configured per beam or can be common for beams. In another example, the configuration of the trigger signal (e.g., sequence used for trigger signal) can be per beam or can be common for beams. The UE (first device transmitting the trigger signal) is informed or configured the resources of the timing window and/or the configuration of the trigger signal of each beam. The UE determines which beam or beams to associated with the transmission of the trigger signal, and hence determine the corresponding time/frequency occasion and trigger signal. In one example, this can be based on positioning information, the UE is configured or informed the position or location or direction or width of each beam, the UE determines its position (e.g., using non-RAT-based methods and/or using RAT-based methods), the UE determines the most suitable (e.g., beam within its coverage) beam or beams for the trigger signal transmission. In one example, this can be based on sensing information, the UE determines the most suitable (e.g., beam within its coverage) beam or beams to associate with the trigger signal transmission. Based on the determined beam or beams and corresponding timing window and/or configuration of the trigger signal, the UE transmits the determined trigger signal associated with the determined beam of beams.

FIGS. 16A, 16B and 16C illustrate example diagrams for signal transmission 1600, 1625, and 1650, respectively, according to embodiments of the present disclosure. For example, signal transmission 1600, 1625, and 1650, respectively, can be transmitted by the UE 115 of FIG. 1. This example is for illustration only and other embodiments can be used without departing from the scope of the present disclosure.

In one example, the first device is provided a timing window configuration and/or trigger signal configuration for a trigger signal to a second device or a beam (spatial domain filter) of a second device wherein the configuration can depend on the second device (e.g., position or location) and/or the beam of the second device (e.g., beam direction which can include azimuth and/or elevation (zenith) angles or beam width). In one such example of configuration can include one or more elements of TABLE 1. In a variant of TABLE 1, there is one configuration per second device, wherein the second device has one beam. In a variant of TABLE 1, there is one configuration per second device, wherein a same configuration is used across the beams of a second device. In a variant of TABLE 1, a same configuration is used for multiple beams of a second device.

TABLE 1
Example configuration of trigger signal for multiple second devices and associated beams

| 2^{nd} Device/2^{nd} | Device | Beam | Timing window | Trigger Signal |
|---|---|---|---|---|
| Device beam | location | Orientation | configuration | configuration |
| 2^{nd} Device1/Beam1 | 2ndDevice1 | Beam1 azimuth | Time and/or | Trigger signal config |
| | position | and/or zenith | frequency resources | (e.g., sequence) |
| 2^{nd} Device1/Beam2 | 2ndDevice1 | Beam2 azimuth | Time and/or | Trigger signal config |
| | position | and/or zenith | frequency resources | (e.g., sequence) |
| . . . | | | | |
| 2^{nd} Device2/Beam1 | 2ndDevice2 | Beam1 azimuth | Time and/or | Trigger signal config |
| | position | and/or zenith | frequency resources | (e.g., sequence) |
| 2^{nd} Device2/Beam2 | 2ndDevice2 | Beam2 azimuth | Time and/or | Trigger signal config |
| | position | and/or zenith | frequency resources | (e.g., sequence) |
| . . . | | | | |

In one example, a first device (e.g., UE) has multiple transmit beams (multiple spatial domain transmission filters). The first device transmits the trigger signal on multiple occasions (e.g., transmit beam sweeping) as illustrated in FIG. 16A. In one example, a number of beams (spatial domain transmission) the first device can transmit trigger signal on is N. In one example, N=1. In one example, N is (pre-)configured. In one example, N can be configured and/or updated by RRC signaling and/or MAC CE signaling and/or L1 control signaling. In one example, N can depend on a UE capability. In one example, the first device repeats the transmission of the trigger signal multiple times so that the second device performs receive sweeping for different receiver beams. In one example, a number of repetitions of the trigger signal transmission using a same transmit beam (spatial domain transmission filter) on the first device is M. In one example, M=1. In one example, M is (pre-)configured. In one example, M can be configured and/or updated by RRC signaling and/or MAC CE signaling and/or L1 control signaling. In one example, as illustrated in FIG. 16A, the first device repeats the trigger signal within each occasion of the trigger signal N times, and transmits across M occasions using same corresponding beams in the M occasions. In one example, as illustrated in FIG. 16B, the first device transmits one trigger signal per occasion, and the first device transmits across N occasions wherein the transmit beam used in each occasion can be different. In a variant of FIG. 16B, the first device transmits across M occasions using a same transmit beam. In a variant of FIG. 16B, the first device transmits across N×M occasions, wherein the first device can use different transmit beam for the first N occasions, then for next N occasions the same set of corresponding transmit beams are used, and for the N occasions afterwards the same set of corresponding transmit beams are again used, and so on, for M times, until the trigger signal has been transmitted on N×M occasions. In variant of FIG. 16B, the first device transmits across N×M occasions, wherein the first device uses a same transmit beam for the first M occasions, uses a different transmit beam for the next M occasions, and so on, for N times, until the trigger signal has been transmitted on N×M occasions. In one example, as illustrated in FIG. 16C, the first device transmits M trigger signals in each transmission occasion using a same beam, and the first device can repeat transmission across N transmission occasions wherein a different transmit beam can be used in each transmission occasion. In a variant example, the first device transmits a trigger signal R times in each transmission occasion and transmits in S transmission occasions, wherein a pattern can determine which trigger signals have a same transmit beam and which trigger signals can have a different transmit beams. The parameters R, S and the pattern can be (pre-)configured, and/or configured or updated by RRC signaling and/or MAC CE signaling and/or L1 signaling.

In one example, when the trigger signal from the first device is repeated in multiple occasions (e.g., based on different spatial domain filters from the first device), the second device can determine a preferred occasion. In one example, the preferred occasion impacts the selection of signal transmitted from second device, e.g., beam management reference signal (BMRS). In one example, the preferred occasion is indicated in the signal transmitted from second device, e.g., beam management reference signal (BMRS). In one example, a preferred occasion can be an occasion that has a best signal quality (e.g., based on RSRP or SINR) for the trigger signal. In one example, a preferred occasion can be an occasion that were the signal quality (e.g., based on RSRP or SINR) for the trigger signal exceeds a threshold.

In one example, when the trigger signal from the first device is repeated in multiple occasions (e.g., based on a same spatial domain filter from the first device), the second device can perform receive beam sweeping to fine tune its spatial domain reception filter.

In one example, a first device (e.g., a UE) can determine a transmit beam direction or a set of N transmit beam directions over which to transmit the trigger signal based on one more of the following:
The orientation of the first device, e.g., using IMU sensors in the device or based on (pre-)configured (e.g., if the device is stationary or doesn't rotate).
The position of the first device.
The beam characteristics of the first device (e.g., beam width)
The position of a second device (e.g., to which the trigger is sent, and/or the device transmitting the beam management reference signal)
The beam direction or beam width of the second device.
Sensing information at the first device.

In one example, the first device (e.g., UE) determines K second devices (e.g., gNB/TRPs) to which to transmit the trigger signal for subsequent reception of beam management reference signals. In one example, K=1. In one example, K is (pre-)configured. In one example, K can be configured and/or updated by RRC signaling and/or MAC CE signaling and/or L1 control signaling. In one example, K can depend on a UE capability.

In one example, the first device (e.g., UE) determines L beams (e.g., receive beams) for a second device (e.g., gNB/TRPs) to which to associate the trigger signal for subsequent reception of beam management reference signals. In one example, L=1. In one example, L is (pre-)configured. In one example, L can be configured and/or updated by RRC signaling and/or MAC CE signaling and/or L1 control signaling. In one example, L can depend on a UE capability.

In one example, the first device (e.g., UE) determines J pairs second devices (e.g., gNB/TRPs) and beams (e.g., receive beams) of second devices to which to associate the trigger signal for subsequent reception of beam management reference signals. In one example, J=1. In one example, J is (pre-)configured. In one example, J can be configured and/or updated by RRC signaling and/or MAC CE signaling and/or L1 control signaling. In one example, J can depend on a UE capability.

In one example, the network includes multiple second devices to which the first device can transmit the trigger signal for subsequent reception of beam management reference signals. One or more of the following can be used to determine the second device or second devices to which the trigger signal for beam management reference signal is transmitted.

In one example, the second device, associated with the trigger signal transmitted by the first device, is determined by the first device based on the device or devices with which the first device is communicating, e.g., has a link with or is in RRC CONNECTED mode with that second device. This can be, for example, a first device communicating with a second device (or multiple second devices) and wants to trigger reception of a beam management reference signal for beam maintenance (e.g., for beam tracking or beam refinement) or for beam failure detection and recovery. In one example, the first device is a UE, and the second device is a gNB/TRP (or multiple gNBs or multiple TRPs for example in the case of coherent joint transmission (CJT) or non-coherent joint transmission (NCJT)). In another example, the first device is a first UE, and the second device is a second UE with which a SL communication link is established. In another example, the first device is a first UE, and the second device is multiple second UEs with which a SL communication link is established (e.g., in case of a UE-group).

In one example, the second device, associated with the trigger signal transmitted by the first device, is determined by the first device based on the device or devices to which the first device wants to establish a communication link. In one example, the trigger signaling is for initial access between the first device and the network, or between the first device and a second device, or between the first device and multiple second devices. In one example, the trigger signal is for mobility of the first device to switch from communicating with or through a first second device or devices to communicating with or through a second-second device or devices. In one example, the first device is a UE and the first second device is a source gNB/TRP (e.g., the BS 102) and the second-second device is a target gNB/TRP. In one example, the first device is a first UE and the first second device is a second UE, and the second-second device is a third UE, wherein the link of the first UE is being transferred from the second UE to the third UE.

In one example, the second device, associated with the trigger signal transmitted by the first device, is determined by the first device based on positioning information. In one example, the first device position or location is determined based on RAT independent positioning schemes (e.g., GNSS, TBS, etc.). In one example, the first device position or location is determined based on RAT dependent positioning schemes. In one example, the RAT dependent positioning schemes can be for a terrestrial network (TN). In one example, the RAT dependent positioning schemes can be for a non-terrestrial network NTN. In one example, if the first device has a network connection, the first device position or location is determined based on RAT dependent positioning schemes. In one example, if the first device has doesn't have a network connection, the first device position or location is determined is based on RAT independent positioning schemes. In one example, the first device is (pre-)configured or configured or updated by RRC signaling and/or MAC CE signaling and/or L1 control signaling with location information of second devices, wherein the second device is the device to which the trigger signal is transmitted, the UE can use this information along with its position/location information to determine one or more second devices. In one example, the first device is (pre-)configured or configured or updated by RRC signaling and/or MAC CE signaling and/or L1 control signaling with beam information (e.g., beam direction and/or beam width) of second devices, wherein the second device is the device to which the trigger signal is transmitted, the UE can use this information along with its position/location information to determine one or more second devices.

In one example, the second device, associated with the trigger signal transmitted by the first device, is determined by the first device based on sensing information. In one example, the first device is (pre-)configured or configured or updated by RRC signaling and/or MAC CE signaling and/or L1 control signaling with location information of second devices, wherein the second device is the device to which the trigger signal is sent. The first device, such as a UE, can use this information along with its sensing information to determine one or more second devices. In one example, the first device is (pre-)configured or configured or updated by RRC signaling and/or MAC CE signaling and/or L1 control signaling with beam information (e.g., beam direction and/or beam width) of second devices, wherein the second device is the device to which the trigger signal is sent, and the first device can use this information along with its sensing information to determine one or more second devices.

In one example, a second device includes multiple beams to which the first device can associated the trigger signal for subsequent reception of beam management reference signals. One or more of the following can be used to determine the second device beam or beams to which the trigger signal for beam management reference signal is transmitted.

In one example, the second device beam, associated with the trigger signal transmitted by the first device, is determined by the first device based on the device or devices or beam or beams of such device(s) with which the first device, such as a UE, is communicating, e.g., has a link with or is in RRC CONNECTED mode with that device. This can be an example, of a first device communicating with a second device (or multiple second devices) and wants to trigger a beam management reference signal for beam maintenance (e.g., for beam tracking or beam refinement) or for beam failure detection and recovery.

In one example, the beam of the second device, associated with the trigger signal transmitted by the first device, is determined by the first device based on the device or devices to which the first device wants to establish a communication link. In one example, the trigger signal from the first device is associated with initial access between the first device and the network, or between the first device and a second device, or between the first device and multiple second devices. In one example, the trigger signal from the first device is associated with mobility of the first device from communicating with or through a first second device or devices to communicating with or through a second-second device or devices.

In one example, the second device beam, associated with the trigger signal transmitted by the first device, is determined based on positioning information of the first device. In one example, the first device position or location is determined based on RAT independent positioning schemes (e.g., GNSS, TBS, etc.). In one example, the first device position or location is determined based on RAT dependent positioning schemes. In one example, the RAT dependent positioning schemes can be for a terrestrial network (TN). In one example, the RAT dependent positioning schemes can be for a non-terrestrial network (NTN). In one example, if the first device has a network connection, the first device position or location is determined based on RAT dependent positioning schemes. In one example, if the first device doesn't have a network (e.g., the network 130) connection, the first device position or location is determined is based on RAT independent positioning schemes. In one example, the first device is (pre-)configured or configured or updated by RRC signaling and/or MAC CE signaling and/or L1 control signaling with location information of second devices, wherein the second device is the device to which the trigger signal is transmitted, the first device, such as a UE, can use this information along with its position/location information to determine one or more second devices or second device beams. In one example, the first device is (pre-)configured or configured or updated by RRC signaling and/or MAC CE signaling and/or L1 control signaling with beam information (e.g., beam direction and/or beam width) of second devices, wherein the second device is the device to which the trigger signal is sent, the first device can use this information along with its position/location information to determine one or more second device beams.

In one example, the second device beam, associated with the trigger signal transmitted by the first device, is determined by the first device based on sensing information. In one example, the first device is (pre-)configured or configured or updated by RRC signaling and/or MAC CE signaling and/or L1 control signaling with location information of second devices, wherein the second device is the device to which the trigger signal is transmitted, the first device can use this information along with its sensing information to determine one or more second devices or second device beams. In one example, the first device is (pre-)configured or configured or updated by RRC signaling and/or MAC CE signaling and/or L1 control signaling with beam information (e.g., beam direction and/or beam width) of second devices, wherein the second device is the device to which the trigger signal is transmitted, the first device can use this information along with its sensing information to determine one or more second device beams.

In one example, a trigger signal from the first device can be a random access preamble signal. In one example, a trigger signal from the first device can be a random access preamble signal followed by a subsequent transmission from the first device, e.g., physical uplink shared channel (PUSCH) transmission if first device is a UE (e.g., the UE 116) and second device is a gNB/TRP. In one example, a trigger signal from the first device can be a random access preamble signal, and if the first device receives an associated acknowledgement (e.g., random access response), the first device can transmit a subsequent signal/channel, e.g., a physical uplink shared channel (PUSCH) if first device is a UE and second device is a gNB/TRP. In one example, a trigger signal from the first device can be a random access preamble signal and, if the first device receives an associated acknowledgement (e.g., random access response), the acknowledgment provides information about a subsequent transmission from the first device (e.g., presence of the subsequent transmission and/or payload size and/or modulation coding scheme and/or time/frequency resources). If subsequent transmission is present, the first device can transmit the subsequent transmission. In one example, the subsequent transmission can include information from the first device to the second device to assist the second device in determining a beam management reference signal to transmit (e.g., which beams to use for the transmission of the beam management reference signal). In one example, the information from the first device can include positioning or location information of first device. In one example, the information from the first device can include sensing information of first device. In one example, based on the information provided by the first device, second device(s) determines or selects beam management reference signals to transmit to the first device.

In one example, a trigger signal from the first device can be an on-off-keying (OOK) signal, or low power (LP) signal, or walk up signal (WUS), or low power WUS (LP-WUS). In one example, a trigger signal from the first device can be an OOK or LP or WUS or LP-WUS signal followed by a subsequent transmission from the first device, e.g., physical uplink shared channel (PUSCH) transmission if the first device is a UE and the second device is a gNB/TRP. In one example, a trigger signal from the first device can be an OOK or LP or WUS or LP-WUS signal, and if the first device receives an associated acknowledgement (e.g., OOK or LP or WUS or LP-WUS response), the first device can transmit a subsequent signal/channel, e.g., a physical uplink shared channel (PUSCH) if first device is a UE and second device is a gNB/TRP. In one example, a trigger signal from the first device can be an OOK or LP or WUS or LP-WUS signal, and if the first device receives an associated acknowledgement (e.g., OOK or LP or WUS or LP-WUS response), the acknowledgment provides information about a subsequent transmission from the first device (e.g., presence of the subsequent transmission and/or payload size and/or modulation coding scheme and/or time/frequency resources). If the subsequent transmission is present, the first device can transmit the subsequent transmission. In one example, the subsequent transmission can include information from the first the device to the second device to assist the second device in determining a beam management reference signal to transmit (e.g., which beams to use for the transmission of the beam management reference signal). In one example, the information from the first device can include positioning or location information of first device. In one example, the information from the first device can include sensing information of first device. In one example, based on the information provided by the first device, second device(s) determines or selects beam management reference signals to transmit to the first device.

In the previous examples, the random access preamble or OOK/LP/WUS/LP-WUS signal (trigger signal from the first device) can be replaced by one or more of:
Reference signal
Reference signal scrambled by a first device specific identity
Reference signal scrambled by a second device specific identity
Reference signal scrambled by a second device beam specific identity
Physical layer control channel
Physical layer control channel that includes a UE specific identity
Physical layer control channel by a second device specific identity
Physical layer control channel by a second device beam specific identity
Physical layer shared channel
Physical layer shared channel that includes a UE specific identity
Physical layer shared channel scrambled by a second device specific identity
Physical layer shared channel by a second device beam specific identity

In one example, a first device can transmit a trigger signal, associated with a beam management reference signal from a second device, to the second device for initial access in order to trigger the second device to transmit a signal for beam management and for the first device to perform initial beam acquisition (e.g., beam pairing) from the second device.

In one example, a first device can have a link to a first second device. The first device can transmit a trigger signal, associated with a beam management reference signal, to a second-second device for mobility, in order to trigger the second-second device to transmit a signal for beam management and for the first device to perform initial beam acquisition (e.g., beam pairing) from the second-second device. Subsequently, the link of the first device to the first-second device, can be transferred to the second-second device.

In one example, a first device can have a link to a first-second device. If the link quality degrades below a threshold, e.g., based on RSRP, or SINR, or reference signal received quality (RSRQ), the first device can transmit a trigger signal, associated with a beam management reference signal from a second device, to the second device for beam maintenance, in order to trigger the second device to transmit a signal for beam management and for the first device to perform beam tracking and beam refinement. In one example, the second device can be the first-second device, for example to find a new beam within the first-second device, e.g., intra-second-device beam management. In one example, the second device can be a second-second device, for example to find a new beam within the second-second device, and the link can be transferred to the second device, e.g., inter-second-device beam management.

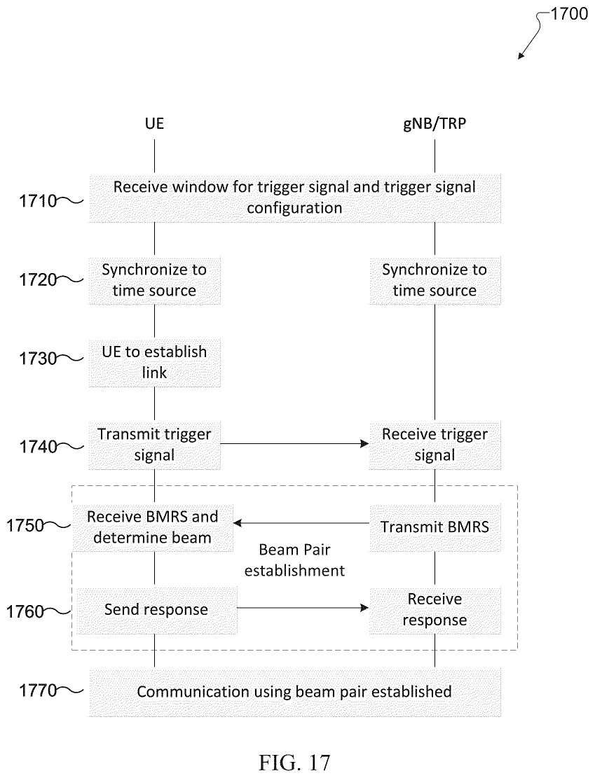

FIG. 17 illustrates a flowchart of an example procedure 1700 for beam management according to embodiments of the present disclosure. For example, procedure 1700 can be performed by the UE 111 and the gNB/TRP 102 and/or network 130 in the wireless network 100 of FIG. 1. This example is for illustration only and other embodiments can be used without departing from the scope of the present disclosure.

The procedure begins in 1710, a UE and gNB/receive window (e.g., time/frequency occasions) for trigger signal and trigger signal configuration is configured. In 1720, the UE and gNB synchronize to a time source. In 1730, the UE is triggered to establish a link. In 1740, the UE transmits a trigger signal to the gNB. In 1750, the gNB transmits beam management reference signal (BMRS) to the UE and the UE determines a beam. In one example, the BMRS is determined based on information provided by the UE. In one example, the trigger signal is transmitted in multiple occasions, the gNB determines a preferred occasion of the trigger and the preferred occasion impacts the selection of BMRS, or the preferred occasion is indicated in the BMRS. In 1760, the UE transmits a response to the gNB. In 1770, the UE and gNB has communication using the beam pair established.

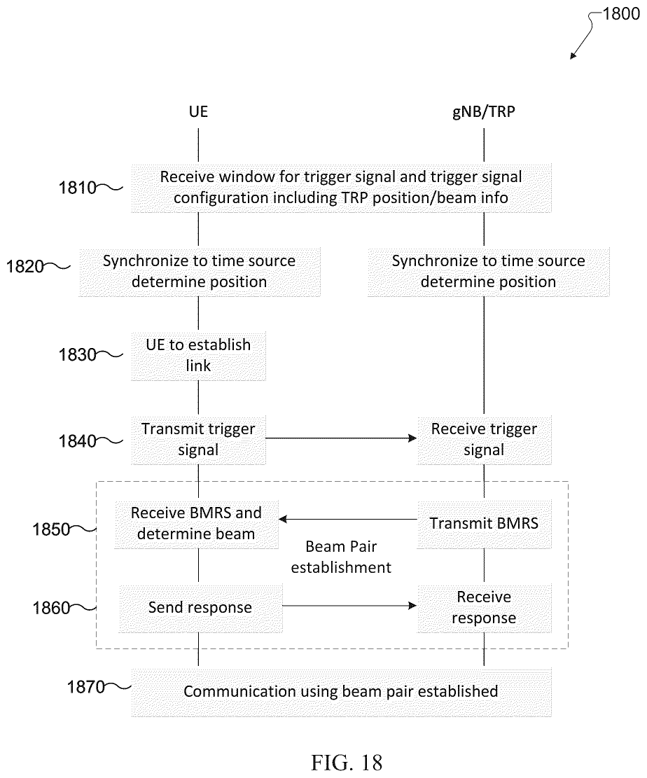

FIG. 18 illustrates a flowchart of an example procedure 1800 for beam management according to embodiments of the present disclosure. For example, procedure 1800 can be performed by the UE 112 and the gNB/TRP 102 and/or network 130 in the wireless network 100 of FIG. 1. This example is for illustration only and other embodiments can be used without departing from the scope of the present disclosure.

The procedure begins in 1810, a UE and gNB/receive window (e.g., time/frequency occasions) for trigger signal and trigger signal configuration including TRP position/beam info is configured. In 1820, the UE and gNB synchronize to a time source and determine position information. In 1830, the UE is triggered to establish a link. In 1840, the UE transmits a trigger signal to the gNB. In one example, the trigger signal can include positioning information. In 1850, the gNB transmits BMRS to the UE and the UE determines a beam. In one example, the BMRS is determined based on information provided by the UE. In one example, the trigger signal is transmitted in multiple occasions, the gNB determines a preferred occasion of the trigger and the preferred occasion impacts the selection of BMRS, or the preferred occasion is indicated in the BMRS. In 1860, the UE transmits a response to the gNB. In 1870, the UE and gNB has communication using the beam pair established.

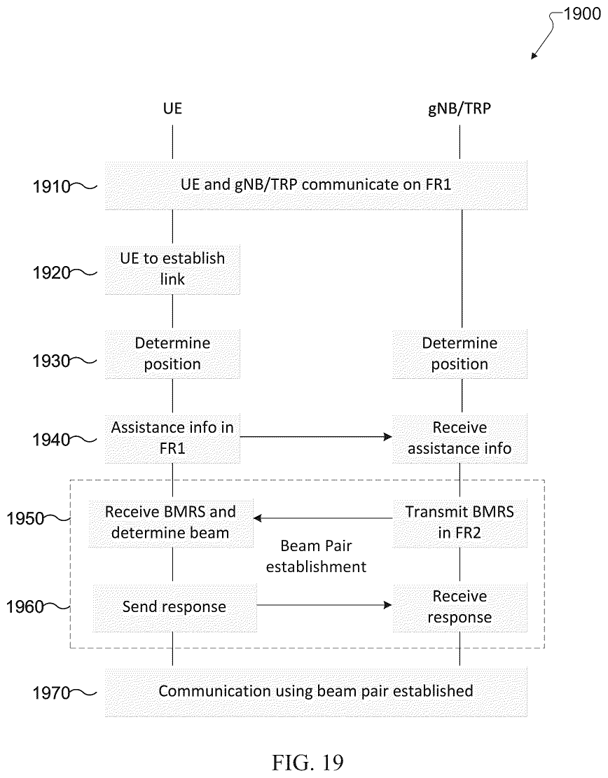

FIG. 19 illustrates a flowchart of an example procedure 1900 for beam management according to embodiments of the present disclosure. For example, procedure 1900 can be performed by the UE 113 and the gNB/TRP 102 and/or network 130 in the wireless network 100 of FIG. 1. This example is for illustration only and other embodiments can be used without departing from the scope of the present disclosure.

The procedure begins in 1910, a UE and gNB/TRP communicate on FR1. In 1920, the UE is triggered to establish a link. In 1930, the UE and gNB determine position information. In 1940, the UE transmits assistance information in FR1 to the gNB. In 1950, the gNB transmits BMRS in FR2 to the UE and the UE determines a beam. In one example, the BMRS is determined based on assistance information provided by the UE. In one example, the trigger signal is transmitted in multiple occasions, the gNB determines a preferred occasion of the trigger and the preferred occasion impacts the selection of BMRS, or the preferred occasion is indicated in the BMRS. In 1960, the UE transmits a response to the gNB. In 1970, the UE and gNB have communication using beam pair established.

As mentioned herein, a first device can use positioning information or sensing information to assist in beam management for a link between the first device and a second device. In one example, the first device is a UE, and the second device is a gNB/TRP. In one example, the first device is a first UE, and the second device is a second UE. In one example, the first device is a gNB/TRP, and the second device is a UE. In one example, the first device is a first network device (e.g., first gNB/TRP) and the second device is a second network device (e.g., second gNB/TRP).

In one example, the position or location of the first device or the second device is determined based on RAT independent positioning schemes (e.g., GNSS, TBS, etc.). In one example, the position or location of the first device or the second device is determined based on RAT dependent positioning schemes. In one example, the RAT dependent positioning schemes can be for a terrestrial network (TN). In one example, the RAT dependent positioning schemes can be for a non-terrestrial network NTN. In one example, if the first device or the second device has a network connection, the position or location of the first device or the second device is determined based on RAT dependent positioning schemes.

In one example, if the first device or the second device doesn't have a network connection, the position or location of the first device or the second device is determined based on RAT independent positioning schemes.

In one example, the first device or the second device uses sensing information to assist with beam management, e.g., to determine beams that are likely to be used for a link between the first device and the second device.

The following provides mechanisms for using positioning information and/or sensing information to assist with beam management.

In one example, a first device uses positioning information and/or sensing information to determine a second device to which a trigger signal, associated with beam management reference signal (BMRS) from the second device, is transmitted to (BMRS from the first device to the second device).

In one example, a first device uses positioning information and/or sensing information to determine a beam associated with a trigger signal transmission to a second device for subsequent reception of beam management reference signals (BMRSs) from the second device.

In one example, a first device transmits its positioning information and/or sensing information to a second device. In one example, the second device uses the positioning information and/or sensing information, from the first device, to determine the transmission beam (spatial domain transmission filter) of the beam management reference signals to transmit to the first device. In one example, the first device transmits positioning information and/or sensing information to the second device along with the trigger signal for subsequent reception of beam management reference signals. In one example, the first device transmits positioning information and/or sensing information to the second device as assistance information where the transmission is in FR1. In one example, the trigger signal is transmitted, from first device to second device, in multiple occasions, the gNB determines a preferred occasion of the trigger and the preferred occasion impacts the selection of BMRS, or the preferred occasion is indicated in the BMRS.

In one example, a first device uses positioning information and/or sensing information to determine the associated transmission beam (spatial domain transmission filter) of the beam management reference signals that are received by the first device.

In the following example, the first device is a UE, and the second device is a gNB/TRP. However, it should be apparent that the first device can be a UE or a gNB and that the second device can be a UE or a gNB.

In one example, as illustrated in FIG. 17, a UE wants to access the network:
1. The UE can be (pre-)configured with timing windows (e.g., time/frequency occasions) for the UE to transmit trigger signals and the gNB/TRP attempts to receive the trigger signals during the gNB/TRP's timing windows.
2. The UE and the gNB/TRP can synchronize to a common time source (e.g., external to the network such as GNSS or TBS, or based on a NTN network or based on a terrestrial network (TN).
3. The UE wants (or is triggered) to establish a link with the network.
4. The UE determines the time/frequency resources of the timing window for the gNB/TRP, and the UE transmits the trigger signal within the timing window (e.g., time/frequency occasions). The network (gNB/TRP) receives the trigger signal.
5. In response to the trigger signal, the network transmits beam management reference signals (BMRS) (e.g., SS/PBCH blocks or CSI-RS). The UE receives the beam management reference signals, and the UE determines a beam to use for subsequent communications with the gNB/TRP. In one example, the BMRS is determined based on information provided by the UE. In one example, the trigger signal is transmitted in multiple occasions, the gNB/TRP determines a preferred occasion of the trigger and the preferred occasion impacts the selection of BMRS, or the preferred occasion is indicated in the BMRS.
6. The UE transmits a corresponding channel or signal to the gNB/TRP. The gNB/TRP receives the channel/signal thus establishing a beam pair to use for communication between gNB/TRP. In one example, the establishment of a beam pair can follow legacy procedure, e.g., BMRS is SSB, after the UE receives the SSB, the UE transmits a PRACH, and signaling of the legacy initial access procedure is followed.

In one example, as illustrated in FIG. 18, a UE wants to access the network and can provide its positioning information or sensing information to the network:
1. The UE can be (pre-)configured with timing windows (e.g., time/frequency occasions) for the UE to transmit trigger signal during the timing windows. The gNB/TRP attempts to receive the trigger signal during the gNB/TRP's timing windows. The configuration information can also include positioning information for the gNB/TRPs, along with beam related information (e.g., azimuth and zenith of beam directions and/or beam width).
2. The UE and gNB/TRP synchronize to a common time source (e.g., external to the network such as GNSS or TBS, or based on a NTN network or based on a terrestrial network (TN). The UE and/or gNB can also determine their corresponding positioning information.
3. The UE wants (or is triggered) to establish a link with the network.
4. The UE can determine a TRP/gNB to send trigger signal to. The UE determines the time/frequency resources of the timing window. The UE can determine (e.g., based on its position and/or orientation) direction of transmission (or transmit beam) to the gNB/TRP. The UE transmits the trigger signal within the timing window and, if any, based on the determined transmit beam. The network receives the trigger signal. In one further example, the UE provides its positioning information or sensing information to network with the trigger signal.
5. In response to the trigger signal, the network transmits beam management reference signals (BMRS) (e.g., SS/PBCH blocks or CSI-RS). If the gNB/TRP receives positioning information from the UE, the network (gNB/TRP) can determine a beam or a subset of beams for the beam management reference signal transmission. The UE receives the beam management reference signals, and the UE determines a beam to use for subsequent communications with the gNB/TRP. In one example, the trigger signal is transmitted in multiple occasions, the gNB/TRP determines a preferred occasion of the trigger and the preferred occasion impacts the selection of BMRS, or the preferred occasion is indicated in the BMRS.
6. The UE transmits a corresponding channel or signal to the gNB/TRP. The gNB/TRP receives the channel/signal thus establishing a beam pair to use for communication between gNB/TRP. In one example, the establishment of a beam pair can follow legacy procedure, e.g., BMRS is SSB, after the UE receives the SSB, the UE transmits a PRACH, and signaling of the legacy initial access procedure is followed.

In one example, as illustrated in FIG. 19, UE can provide its positioning information or sensing information to network as assistance information:
1. The UE and the network (gNB/TRP) can communicate in FR1.
2. The UE or the network want (or is triggered) to establish a link in FR2.
3. The UE and/or the network can determine their corresponding positioning information.
4. The UE provides assistance information to the network on FR1 to assist with beam/link establishment in FR2. The assistance information can include positioning information or sensing information.
5. In response to the assistance information, the network transmits beam management reference signals (BMRS) (e.g., SS/PBCH blocks or CSI-RS). If the gNB/TRP receives positioning information from the UE, the network can determine a beam or a subset of beams to transmit the beam management reference signal to the UE. The UE receives the beam management reference signals, and the UE determines a beam to use for subsequent communications with the gNB/TRP. In one example, the trigger signal is transmitted in multiple occasions, the gNB/TRP determines a preferred occasion of the trigger and the preferred occasion impacts the selection of BMRS, or the preferred occasion is indicated in the BMRS.
6. The UE transmits a corresponding channel or signal to the gNB/TRP. The gNB/TRP receives the channel/signal thus establishing a beam pair to use for communication between gNB/TRP. In one example, the establishment of a beam pair can follow legacy procedure, e.g., BMRS is SSB, after the UE receives the SSB, the UE transmits a PRACH, and signaling of the legacy initial access procedure is followed.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first configuration information for one or more transmission occasions for one or more first signals, respectively, wherein the first configuration information indicates (i) periodicity of the one or more transmission occasions and (ii) an offset relative to a reference source, and
synchronize to the reference source for timing information; and
a processor operably coupled to the transceiver, the processor configured to:
evaluate a condition to transmit a first signal from the one or more first signals, and
determine the first signal,
wherein the transceiver is further configured to, when the condition is satisfied:
transmit the first signal in a corresponding transmission occasion, and
receive, in response to the first signal, a second signal for beam management.

2. The UE of claim 1, wherein:
the transceiver is further configured to receive second configuration information about a position of one or more devices that receive the one or more first signals, respectively, and
the first signal is determined based on the second configuration information and a position of the UE.

3. The UE of claim 1, wherein:
the first signal is transmitted based on multiple spatial domain transmission filters, and
the second signal is associated with a preferred spatial domain transmission filter from the multiple spatial domain transmission filters.

4. The UE of claim 1, wherein the first signal is a physical random access channel (PRACH).

5. The UE of claim 1, wherein the second signal is a synchronization signal/broadcast channel (SS/PBCH) block or a channel state information-reference signal (CSI-RS).

6. The UE of claim 1, wherein the first signal includes position information of the UE.

7. The UE of claim 1, wherein the condition to transmit the first signal is based on:
initial access of the UE to a network,
mobility of the UE from a first cell to a second cell, or
beam failure recovery.

8. A base station (BS) system, comprising:
a first BS comprising a transceiver and a processor operably coupled with the transceiver; and
one or more second BSs, a second BS of the one or more second BSs comprising a transceiver and a processor operably coupled with the transceiver,
wherein the transceiver of the first BS is configured to transmit first configuration information for one or more transmission occasions for one or more first signals, respectively, wherein the first configuration information indicates (i) periodicity of the one or more transmission occasions and (ii) an offset relative to a reference source,
wherein the transceiver of the second BS is configured to receive the first signal,
wherein the processor of the second BS configured to detect a presence of the first signal, and
wherein the transceiver of the second BS further configured to transmit, in response to the first signal, a second signal for beam management.

9. The BS system of claim 8, wherein the transceiver of the first BS is further configured to transmit second configuration information about a position of the one or more second BSs that receive the one or more first signals, respectively.

10. The BS system of claim 8, wherein:
the transceiver of the second BS is further configured to receive the first signal in multiple instances,
the processor of the second BS is further configured to determine a preferred instance of the multiple instances, and
the transceiver of second BS is further configured to transmit the second signal associated with the preferred instance.

11. The BS system of claim 8, wherein the first signal is a physical random access channel (PRACH).

12. The BS system of claim 8, wherein the second signal is a synchronization signal/broadcast channel (SS/PBCH) block or a channel state information-reference signal (CSI-RS).

13. The BS system of claim 8, wherein the first signal includes position information of a UE transmitting the first signal.

14. A method of operating a user equipment (UE), the method comprising:
receiving first configuration information for one or more transmission occasions for one or more first signals, respectively, wherein the first configuration information indicates (i) periodicity of the one or more transmission occasions and (ii) an offset relative to a reference source;
synchronizing to the reference source for timing information;
evaluating a condition to transmit a first signal from the one or more first signals;
determining the first signal; and
when the condition is satisfied:
transmitting the first signal in a corresponding transmission occasion, and
receiving, in response to the first signal, a second signal for beam management.

15. The method of claim 14, further comprising:
receiving second configuration information about a position of one or more devices that receive the one or more first signals, respectively,
wherein determining the first signal further comprises determining the first signal based on the second configuration information and a position of the UE.

16. The method of claim 14, wherein:
transmitting the first signal further comprises transmitting the first signal based on multiple spatial domain transmission filters, and
the second signal is associated with a preferred spatial domain transmission filter from the multiple spatial domain transmission filters.

17. The method of claim 14, wherein the first signal is a physical random access channel (PRACH).

18. The method of claim 14, wherein the second signal is a synchronization signal/broadcast channel (SS/PBCH) block or a channel state information-reference signal (CSI-RS).

19. The method of claim 14, wherein the first signal includes position information of the UE.

20. The method of claim 14, wherein the condition to transmit the first signal is based on:
initial access of the UE to a network,
mobility of the UE from a first cell to a second cell, or
beam failure recovery.
